(19) United States
(12) Patent Application Publication
(10) Pub. No.: US 2004/0043158 A1
(43) Pub. Date: Mar. 4, 2004

(54) Weather-resistant polymeric coating

(76) Inventors: Paul B. Schultz, Export, PA (US); Joseph D. Guthrie, Murrysville, PA (US); Sherri F. McCleary, Apollo, PA (US); James M. Marinelli, Murrysville, PA (US); Francine S. Bovard, Pittsburgh, PA (US)

Correspondence Address: ALCOA INC, ALCOA TECHNICAL CENTER, 100 TECHNICAL DRIVE, ALCOA CENTER, PA, 15069-0001, US

(21) Appl. No.: 10/233,988

(22) Filed: Sep. 4, 2002

(51) Int. Cl. B05D 1/36

(52) U.S. Cl. 427/407.1

(57) ABSTRACT

A weather-resistant polymeric coating is applied to an aluminum alloy body by coating a surface portion of the body with a primer composition comprising a vinylphosphonic acid-acrylic acid copolymer to form a primer layer, followed by coating the primer layer with a weather-resistant polymeric coating composition. The aluminum alloy body preferably comprises an aluminum alloy extrusion containing an alloy of the AA5000 or AA6000 series. The coating composition preferably contains a cyano modified saturated carboxylated polyester or a zinc rich epoxy, each preferably applied by powder coating.

### FIELD OF THE INVENTION

The present invention relates to weather-resistant coatings for aluminum alloy bodies. The coated products are used for architectural applications and as components of vehicle bodies.

### BACKGROUND OF THE INVENTION

Although aluminum and its alloys protect themselves against corrosion by forming an oxide coating, the protection is not complete. In the presence of moisture and certain electrolytes, aluminum and its alloys may corrode very quickly. Such moisture and electrolytes may originate for example in rainwater, water puddles on roadways, and salt applied to snow-covered roads. Coatings comprising organic polymers and silicones protect aluminum to a limited extent by themselves, but they are usually poorly adherent to metal substrates without an intermediate treatment or layer. Also, thin coatings may be porous, thereby requiring an intermediate coating or layer to improve corrosion resistance of the aluminum alloy substrate.

Accordingly, there remains a need to treat aluminum substrates with primer or other chemicals providing improved corrosion resistance and bonding affinity for subsequent coatings.

In the prior art, chemical conversion coatings have been formed on aluminum by “converting” a surface of the metal into a tightly adherent coating, part of which consists of an oxidized form of aluminum. Chemical conversion coatings provide high corrosion resistance and improved bonding affinity for polymer coatings. A chromate conversion coating is typically provided by contacting aluminum with an aqueous solution containing hexavalent or trivalent chromium ions, phosphate ions and fluoride ions. In recent years, concerns have arisen regarding the pollution effects of chromates and phosphates discharged into waterways by such processes. Because of the high solubility and strongly oxidizing character of hexavalent chrominium ions, expensive waste treatment procedures must be employed to reduce the hexavalent chromium ions to trivalent chromium ions for waste disposal.

Attempts have been made in the prior art to produce acceptable chromate-free conversion coatings for aluminum. For example, some chromate-free conversion coatings contain zirconium, titanium, hafnium and/or silicon, sometimes combined with fluorides, surfactants and polymers such as polyacrylic acid. In spite of the extensive efforts that have been made previously, there is still no entirely satisfactory non-chromate conversion coating or primer for improving the adhesion and corrosion resistance of coated aluminum alloy bodies to be used in outdoor architectural applications. Two of the major problems are that the chromate-free conversion coatings usually provide weaker adhesion of the subsequent coating to the substrate, or the chromate-free conversion coatings provide less corrosion resistance in aggressive environments, or both.

A principal objective of the present invention is to provide aluminum alloy bodies with a primer layer, which provides better corrosion resistance and better adhesion of subsequent coatings than a chromate conversion coating.

A related objective of our invention is to provide a coated aluminum body having a primer layer free of chromium and comprising a reaction product of a vinylphosponic acid-acrylic acid copolymer and an aluminum oxide or hydroxide layer on a surface portion of the body.

Additional objectives and advantages of our invention will become apparent to persons skilled in the art from the following detailed description of some preferred embodiments.

### SUMMARY OF THE INVENTION

In accordance with the present invention there is provided a process for coating aluminum alloy bodies to improve their resistance to corrosion. The aluminum alloy bodies may be extrusions, wrought products, plate, or castings and are preferably hollow extrusions used for window frames, door frames, railings, flag poles, fence posts, and columns. Coated aluminum alloy extrusions and castings of our invention are also suitable for use as components of vehicle bodies.

Some suitable aluminum alloys of the present invention include aluminum-magnesium alloys of the AA5000 series and aluminum-magnesium-silicon alloys of the AA6000 series. In a particularly preferred outdoor architectural application, we utilize AA6063 extrusions. For outdoor sheet and plate applications we prefer aluminum-magnesium alloys and particularly the AA5005 alloy. For making vehicle body components we prefer aluminum-magnesium-silicon alloy extrusions of the AA6000 series and AA 5000 series sheet.

The natural oxide coating on aluminum surfaces is generally sufficient for practice of our invention. The natural oxide coating ordinarily has a thickness of about 30-50 angstroms. Also, the oxide coatings remaining after cleaning, cleaning and desmutting, or cleaning followed by etching and desmutting, are all sufficient for practice of our invention. It is not necessary to grow the oxide coating by treatments such as anodic oxidation or hydrothermal treatments in water, water vapor, or aqueous solutions.

The aluminum body to be coated is cleaned with an alkaline or acid surface cleaner to remove any residual organic contaminants adhering to the surface, and then rinsed with water. Cleaning may be avoided if the organic contamination is negligible.

The cleaned aluminum surface is then primed with a primer composition comprising an aqueous solution of about 0.1-200 g/L of a vinylphosphonic acid-acrylic acid copolymer (VPA-AA copolymer). Solutions containing about 1-20 g/L of the copolymer are preferred. The copolymer usually comprises about 5-50 mole % vinylphosphonic acid groups, preferably about 20-40-mole %. A particularly preferred VPA-AA copolymer contains about 30 mole % VPA. The solution has a temperature of about 50-200° F. There is an inverse relationship between the temperature and time required for coating: the lower the temperature, the longer the time required; or the shorter the time available, the higher the temperature required. A temperature of about 65-85° F. is preferred with an immersion time of about 15 seconds to 2 minutes, thereby minimizing equipment and heating requirements. When speed is critical, a temperature of about 170° F. and a time of about 15 seconds are preferred. Many different combinations of time and temperature are suitable.

The aluminum surface may be dipped into the primer composition or the composition may be sprayed onto the metal surface. The VPA-AA copolymer reacts with the oxide or hydroxide coating to form a primer layer on the metal surface.

Optionally, the aluminum alloy body may be rinsed with water to remove a portion of the VPA-AA copolymer unreacted with the oxide or hydroxide coating. The rinse water may have a temperature of about 35-200° F. Room temperature rinse water is preferred unless quick drying is required, in which case heated water speeds the drying process. The rinse water may be concentrated by removing excess water so that the VPA-AA copolymer can be recycled. Some preferred concentrating techniques include reverse osmosis and membrane filtration.

The primer layer is coated with a weather-resistant coating composition. The coating composition preferably contains at least one polymer selected from polyesters, acrylics, polyvinyl chloride, and epoxies. A cyano modified saturated carboxylated polyester is preferred. The coating composition may be applied to the primed body by electrocoating, spraying, or powder coating. Powder coating is particularly preferred. The coating composition may also contain additives such as dyes, pigment particles, anticorrosion agents, antioxidants, adhesion promoters, light stabilizers, lubricants, and various combinations thereof.

The coated body is dried or cured, in accordance with the needs of the particular composition utilized.

### DETAILED DESCRIPTION OF PREFERRED EMBODIMENTS

Samples of AA6063 alloy extrusions were cleaned with an alkaline surface cleaner and desmutted in an aqueous solution containing nitric acid and ammonium hydrogen fluoride. The cleaned and desmutted extrusions were then pretreated with either an aqueous solution containing a VPA-AA copolymer including about 30 mole % VPA groups and about 70 mole % AA groups (present invention), or a prior art chrome conversion coating. The pretreated samples were then powder coated with a coating composition containing as its principal ingredient a cyano modified saturated carboxylated polyester, and cured by heating at 225° C. for 20 minutes. After organic coating and curing, all samples were subjected to 1000 hours of acetic acid testing per British Standard BS 6496. As shown below, the samples pretreated with a VPA-AA copolymer performed better than either the unpretreated control or the chrome conversion coated sample.

### EXAMPLE 1

### British Standard BS 6496

A. The sample was cleaned, desmutted, and then powder coated without any pretreatment.

Result: One 4 mm blister on the X scribe. Three additional blisters 12-14 mm each at coated edges and coated drilled hole.

B. The sample was cleaned and desmutted, followed by pretreatment with the VPA-AA copolymer solution at 77° C. (170° F.) for 10 seconds, rinsed with water at 77° C. (170° F.) for 10 seconds, air blow dried, and powder coated the next day.

Result: One 1 mm blister on the X scribe.

C. The sample was cleaned and desmutted, followed by VPA-AA copolymer pretreatment at room temperature for 1 minute 40 seconds, rinsed with water at room temperature for 10 seconds, oven dried at 120° C. (2500 F) for 8 minutes, and powder coated the next day.

Result: No defects.

D. The sample was cleaned and desmutted, followed by VPA-AA pretreatment at 77° C. (170° F.) for 1 minute 40 seconds, water rinsed at 77° C. (170° F.) for 10 seconds, air blow dried, and powder coated the next day.

Results: No defects.

E. The sample was cleaned and desmutted, chrome conversion coated, and then powder coated without further treatment.

Result: About 8 blisters 1-2 mm diameter each, all along the X scribe. Also, 1 blister of 2 mm diameter along the coated edge.

### EXAMPLE 2

### Dry Bottom MASTMAASIS Exposure Test (ASTM G85-A2)

The purpose of this test was to compare the relative effectiveness of a prior art chrome-phosphate pretreatment and a VPA-AA copolymer pretreatment on AA 6063 alloy extrusions. The extrusions were cleaned and desmutted in a single step with a Parco 202 acid cleaner for 20 seconds at 170° F. This cleaner is available from Henkel Surface Technologies, of Madison Heights, Mich. After application of the pretreatment, 2 different powder-coat primer systems were evaluated; a cyano modified saturated carboxylated polyester primer and a zinc-rich epoxy primer.

Three replicates were generated of each condition tested. After priming, the specimens were scribed and then subjected to a 4-week Dry Bottom MASTMAASIS exposure test (ASTM G85-A2). After exposure, the specimens were evaluated for both the number and length of filiform corrosion sites. The comparison results for VPA-AA copolymer and chrome phosphate are shown in the following table:

| | | | | Average of 5 | |
|---|---|---|---|---|---|
| | | | Single | maximum sites in | |
| | | | maximum | inches (standard | |
| | | Number of | site length | deviation in | |
| Pretreatment | Primer | Sites | (inches) | parentheses) | |
| VPA-AA | Polyester | 46 | 0.07 | 0.06 | (0.01) |
| Copolymer | | | | | |
| VPA-AA | Polyester | 39 | 0.18 | 0.15 | (0.05) |
| Copolymer | | | | | |
| VPA-AA | Polyester | Numerous | 0.44 | 0.36 | (0.08) |
| Copolymer | | | | | |
| Chrome | Polyester | Numerous | 0.45 | 0.39 | (0.05) |
| Chrome | Polyester | Numerous | 0.49 | 0.35 | (0.11) |
| Chrome | Polyester | 41 | 0.10 | 0.08 | (0.02) |
| VPA-AA | Zinc-Rich | 0 | 0 | 0 | |
| Copolymer | Epoxy | | | | |
| VPA-AA | Zinc-Rich | 0 | 0 | 0 | |
| Copolymer | Epoxy | | | | |
| VPA-AA | Zinc-Rich | 0 | 0 | 0 | |
| Copolymer | Epoxy | | | | |
| Chrome | Zinc-Rich | 2 | 0.06 | 0.03 | (0.03) |
| | Epoxy | | | | |
| Chrome | Zinc-Rich | 1 | 0.03 | 0.01 | (0.01) |
| | Epoxy | | | | |
| Chrome | Zinc-Rich | 1 | 0.02 | 0.01 | (0.01) |
| | Epoxy | | | | |

Results of these tests show that the VPA-AA copolymer pretreatment worked slightly better for the polyester primer. For the zinc-rich epoxy primer, there was no corrosion with the VPA-AA copolymer pretreatment, but corrosion occurred in all samples given the chrome pre-treatment.

Having described the presently preferred embodiments, it is to be understood that the invention may be otherwise embodied within the scope of the appended claims.

What is claimed is:

1. A process for coating an aluminum alloy body with a weather-resistant polmeric coating, comprising
a) providing an aluminum alloy body having a surface portion,
b) coating said surface portion with a primer composition comprising a vinylphosphonic acid-acrylic acid copolymer, thereby to form a primer layer, and
c) coating said primer layer with a weather-resistant polymeric coating composition.

2. The process of claim 1, wherein said body comprises an aluminum alloy of the AA5000 or AA6000 series.

3. The process of claim 1, wherein said body, comprises an aluminum alloy extrusion, wrought product, plate, or casting.

4. The process of claim 1, wherein said copolymer comprises about 5-50 mole % vinylphosphonic acid groups and about 50-95 mole % acrylic acid groups.

5. The process of claim 1, wherein said copolymer comprises about 20-40 mole % vinylphosphonic acid groups.

6. The process of claim 1, wherein said, primer composition comprises about 1-20 g/L of said copolymer dissolved in water.

7. The process of claim 1, wherein said polymeric coating composition comprises at least one polymer selected from the group consisting of polyesters, acrylics, polyvinyl chloride, and epoxies.

8. The process of claim 7, wherein said polymer includes a cyano modified saturated carboxylated polyester.

9. The process of claim 7, wherein said coating composition contains a zinc rich epoxy.
